(19) United States
(12) Patent Application Publication
(10) Pub. No.: US 2004/0213917 A1
(43) Pub. Date: Oct. 28, 2004

(54) Spray booth and filter system

(76) Inventor: Douglas L. Courtney, Trophy Club, TX (US)

Correspondence Address: David W. Carstens, PO Box 802334, Dallas, TX, 75380-2334, US

(21) Appl. No.: 10/422,001

(22) Filed: Apr. 23, 2003

(51) Int. Cl. H05H 1/26; B05B 15/12; B01D 1/16

(52) U.S. Cl. 427/446; 118/326; 118/634; 454/55

(57) ABSTRACT

The improved air booth evacuates paint spray and other particulates from the booth by altering the permeability of filter media in various zones. Adjacent to the centerline of the booth is a first zone. This first zone has the highest permeability, and thus the highest air velocity through it. A second zone is between the first zone and the side walls of the booth. The second zone can have some increased resistance to air flow, reducing the velocity of air passing through the second zone. A third zone between the side walls and the second zone can provide an intermediate level of permeability.

### TECHNICAL FIELD OF THE INVENTION

The present invention relates to an improved spray booth and a filter system. Specifically, the spray booth is used for applying paint to a vehicle and the air filter system provides a means for tailoring the airflow around the vehicle to minimize the risk that overspray and other particulates might impact the wet surface of the vehicle.

### BACKGROUND TO THE INVENTION

Cars and other vehicles are painted for both functional and aesthetic reasons. The paint protects the car's metal from corrosive elements, and also allows the owner to enjoy the car's appearance. A technician can apply the paint in a spray booth. The paint is sprayed on to the vehicle with a sprayer. However, if the technician inadvertently misses the vehicle, some of the paint mist will become suspended in air within the booth. It is not uncommon for the suspended paint (or overspray) to drift around the interior of the booth and land on the vehicle in a way that diminishes the quality of the painted surface. The booth can have a ventilation system to assist with the drying of the paint and to help exhaust any paint mist suspended in the air around the vehicle. Outside air enters the booth through a filter system that removes entrained dust. The air flows down and around the vehicle and through a vent underneath the vehicle. Thus, the paint mist or other particulates are swept with the ventilation air out of the booth.

A downdraft ventilation system is shown in greater detail in FIG. 1. A booth 10 is an enclosure 12 having a plenum 14. A filter 16 separates the plenum from the work area 18. Sidewalls 20 and a floor make up the rest of the enclosure. The vehicle 2 sits on a vent 22 that is the low-pressure source. The object being painted, however, is not limited to a vehicle and can be any object. Thus air enters the plenum at a higher pressure and exits through the vent at a lower pressure. The difference in pressure between the plenum 14 and the exhaust vent 22 is represented by the formula:

Pₚₗₑₙᵤₘ−Pₑₓₕₐᵤₛₜ=ΔP (pronounced delta P)

where P denotes pressure. A portion of the pressure drop, ΔP, is caused by the presence of the filter media 16. Air is supplied under pressure to the plenum from a supply 24. A diffuser 26 can make the air pressure within the plenum more uniform.

The pressure differential is related to the velocity of the air flow across the vehicle. High pressure differentials result in higher air velocities. Thus, it is important to appreciate the pressure fields that exist in the plenum and the exhaust. With a prior art spray booth, the pressure in the plenum was essentially uniform. Likewise, the pressure drop across the filter media was essentially uniform for all points on the media. Further, an exhaust fan creates a uniform low pressure in the exhaust system. This produces a relatively uniform air velocity profile within the booth.

A need exists for a method of tailoring the air velocity profile within the booth to assist in the isolation and entrainment of paint mist and other particulates.

### SUMMARY OF THE INVENTION

The present invention addresses the unmet needs of prior art spray booths by helping evacuate paint spray and other particulates from the booth. It accomplishes this by altering the permeability of filter media in various zones. In one embodiment, the spray booth has four filter panels. Each panel borders the longitudinal axis of the booth. This axis defines the length of the booth and also represents the general orientation of any vehicle within the booth. Adjacent to the centerline is a first zone. This first zone has the highest permeability, and thus the highest air velocity through it. A second zone is between the first zone and the side walls of the booth. The second zone can have some increased resistance to air flow, reducing the velocity of air passing through the second zone. A third zone between the side walls and the second zone can provide an intermediate level of permeability.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a perspective view of a prior art spray booth;

FIG. 2 is a sectional schematic of a spray booth that embodies the present invention;

FIG. 3 is a sectional view across the plenum of a spray booth showing a plurality of permeability zones on the filter media;

FIG. 4 illustrates a prior art filter media;

FIGS. 5, 6, 7, 8 and 9 provide a sectional view across various filter media designs that are tailored to provide a higher velocity air flow around the vehicle;

FIG. 10 illustrates that the filter media can be paneled between the plenum and the work area; and

FIG. 11 shows a method of affecting the pressure distribution in the plenum by suspending plates having holes over part of the filter media.

### DETAILED DESCRIPTION OF THE INVENTION

The present invention provides a tailored air flow velocity profile around a vehicle in a spray booth. This profile helps entrain paint mist from an overspray in the air flow, quickly exhausting it from the booth. FIG. 2 is a sectional schematic of a spray booth 100. It has a work area 102 and a plenum 104. A filter 106 separates the plenum and work area. Air is supplied to the plenum from a supply 110. A fan 112 is used to create a first pressure in the plenum 104. A heater 114 can be used to warm the air.

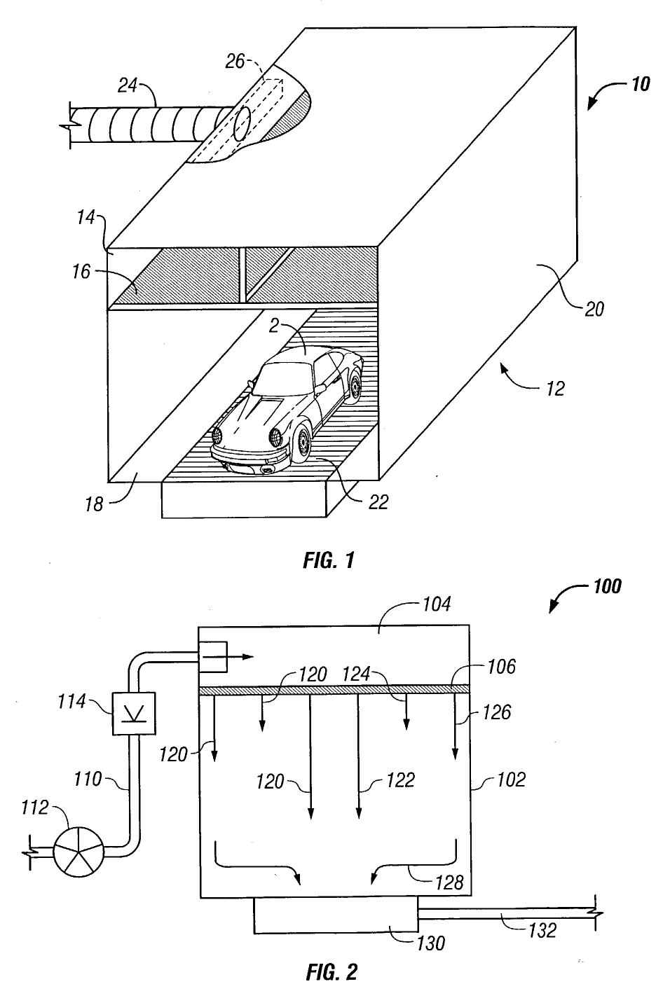

In practice, it is common for the air flow supply 110 into a prior art spray booth to be approximately 12,000 cubic feet per minute. A diffuser 26 (see FIG. 1) is used to aid air flow distribution into the plenum 104. Once the air enters the plenum it diffuses through the filter 106. The filter eliminates the great majority of particulate matter in the air. Most filter media must be effective at capturing particulates 8 microns and greater in diameter. Particulates above 10 microns in diameter tend to be visible if captured in the paint. Arrows 120 represent velocity vectors of the air exiting the filter 106. Note that longer velocity vectors represent faster air flow. Arrow 122 represents the air flow through a first zone in the filter 106. This first zone has the greatest permeability and thus presents the least pressure drop. The first zone is located near the middle of the booth so that the fastest air travels in an envelope around the vehicle. The enveloping effect is further enhanced by the relatively smaller surface area available at the exhaust plenum 130 as compared to the supply plenum 104. Arrow 124 represents air flow through a second zone. In this instance, that flow is impeded by a lower permeability. Thus, the air flow from the second zone is relatively much slower. When a restriction to flow is used, such as in the second zone, the air flow velocity in the first zone can actually increase.

In one embodiment, two distinct zones can be created. In other embodiments, multiple zones can be created. For example, in FIG. 2, a third zone adjacent to the side walls of the booth is shown with vectors 126. This third zone can have a higher permeability than the second zone. For example, the first zone can have 100% of available permeability. The second zone could have 30%, while the third zone has 50%. This creates a slightly faster air flow along the walls of the booth. The air from each zone enters an exhaust plenum 130 and finally exits through an exhaust line 132. The low pressure on the exhaust line can be created by an exhaust fan. In one embodiment, the first zone has a pressure drop of approximately 0.40 inch of water gauge. Thus, the second zone might have a pressure drop of 0.60 inch of water gauge.

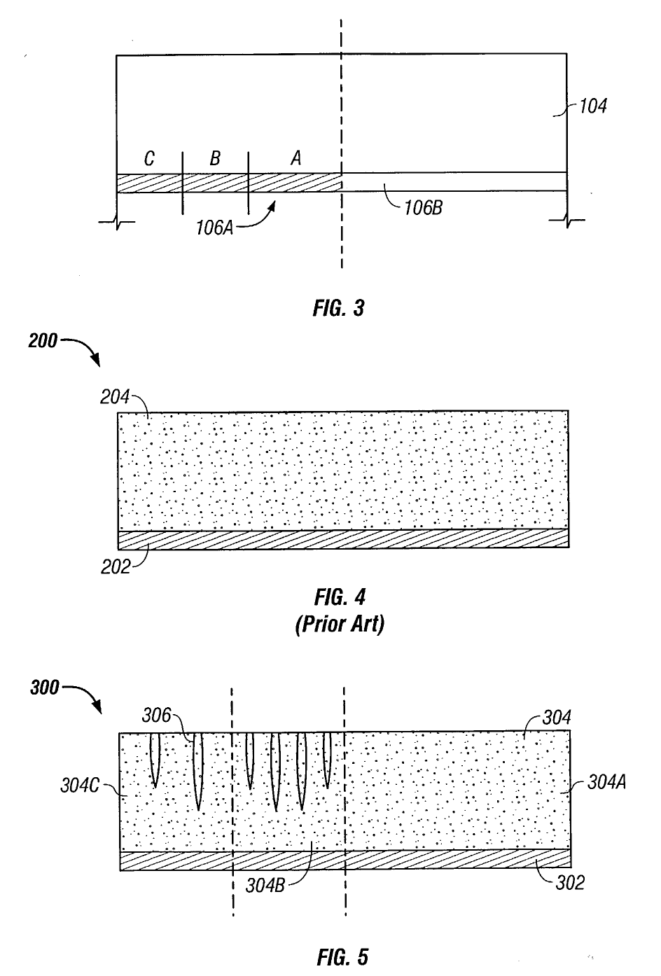

The width of each zone can be modified to match the size of the vehicles. In one embodiment, the width of the booth is equal to the widths of two filters. If each filter is seven feet wide, the first zone might be four feet, the second zone is two feet, and the third zone is one foot in width. The filters are placed into the booth so that the first zones are adjacent to each other in the center of the booth. Thus, a combined first zone might have an eight feet width. FIG. 3 shows two filters 106a and 106b that together span the width of the plenum. Each has three zones, indicated by the letters A, B, and C. Of course, as mentioned above, the filter should have at least two zones with differing permeability.

FIG. 4 shows the cross section of a standard filter 200. It includes a scrim 202 and a loft 204. The scrim is a mesh that provides some stiffness to the filter. The loft is typically a woven polyester that captures dust and other particles. The loft can be improved with the addition of chemicals that bond captured dust to the loft so that physical agitation does not release the particulates.

FIG. 5 shows a modified filter 300 that could be incorporated into the present invention. The filter has a scrim 302. However, the loft 304 has been altered with the addition of low permeability material (LPM) 306 that has been knitted or otherwise physically introduced into the loft. The dotted lines represent the rough division of the filter into distinct zones. More of the LPM has been introduced into the second zone 304B. This creates a higher pressure drop across that zone.

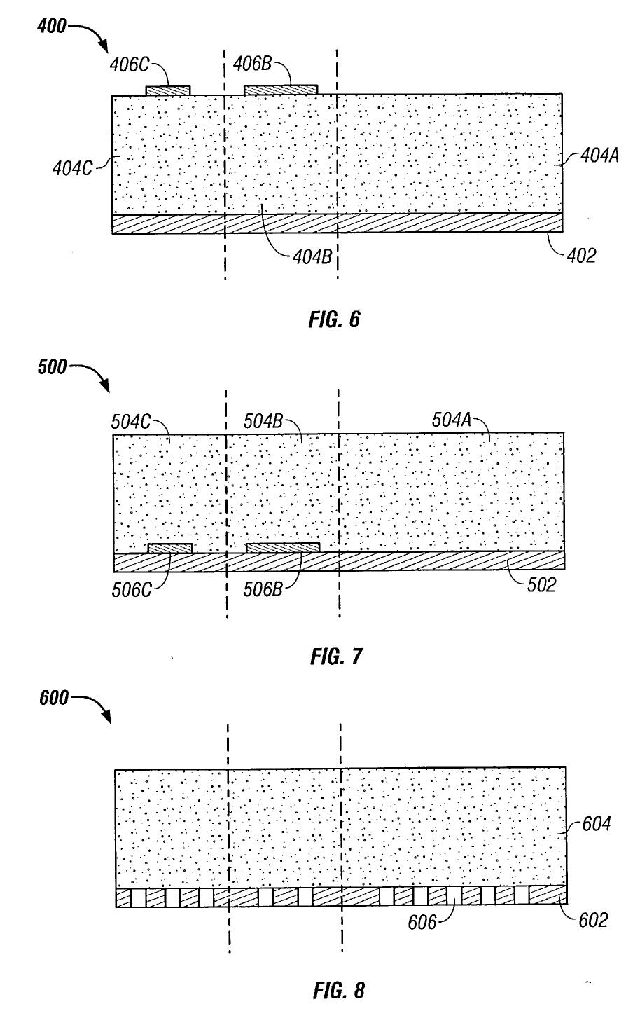

FIG. 6 is another embodiment of the filter. The filter 400 has a scrim 402. However, an LPM 406 has been placed on the upper surface of the loft 404. The LPN 406B can be a more tightly woven material, a non-woven, or a knit material. The difference in permeability is designed to reduce the velocity of the air passing through the media by 30 to 75%. This in turn can cause an increase in the velocity of the air through the media in the first zone by 10 to 30%. The third zone has its permeability decreased by 20 to 60%.

FIG. 7 shows an embodiment 500 wherein the LPM is placed between the loft 504 and the scrim 502. FIG. 8 shows an embodiment wherein the scrim has a plurality of holes therethrough. More holes in the first zone provides greater permeability and thus greater air velocity. FIG. 9 shows the loft having holes penetrating through a portion on its depth. More holes in the first zone provides greater permeability and thus greater air velocity.

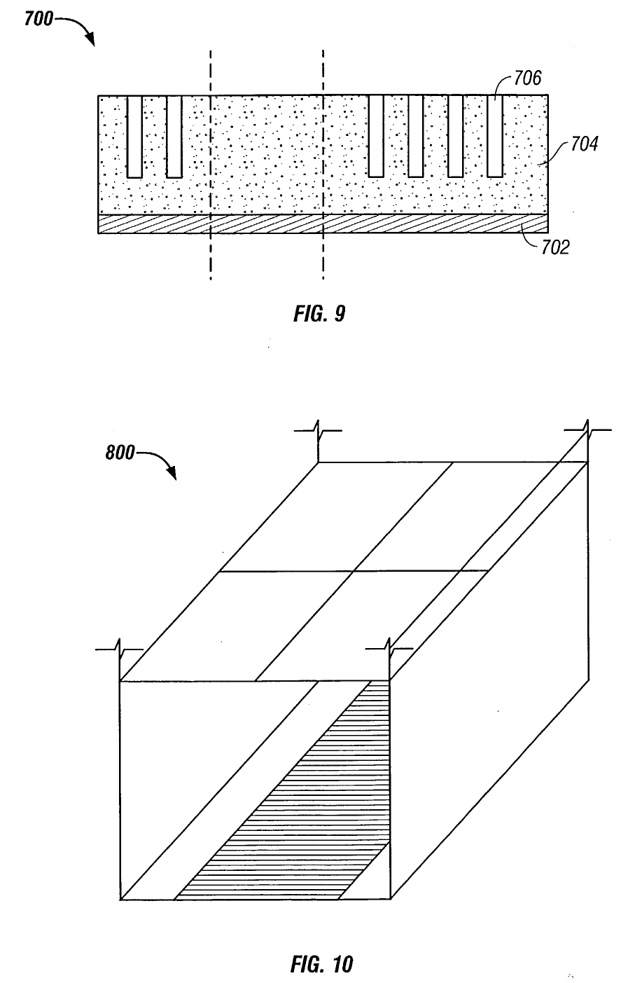

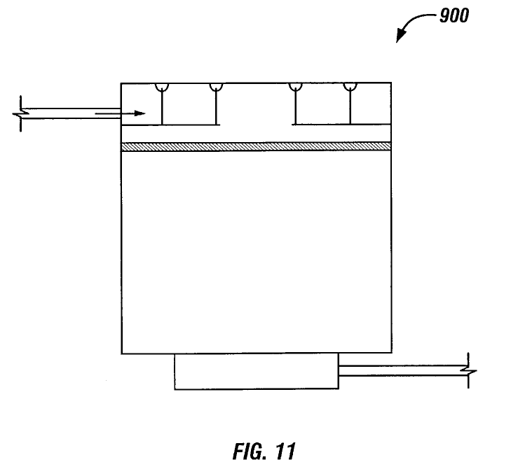

FIG. 10 shows a perspective view of the top of the booth wherein four separate filters 800 are used to provide filtering and velocity control. FIG. 11 shows a method of affecting the pressure distribution in the plenum by suspending plates 900 having holes over part of the filter media.

Although preferred embodiments of the present invention have been described in the foregoing Detailed Description and illustrated in the accompanying drawings, it will be understood that the invention is not limited to the embodiments disclosed, but is capable of numerous rearrangements, modifications, and substitutions of steps without departing from the spirit of the invention. Accordingly, the present invention is intended to encompass such rearrangements, modifications, and substitutions of steps as fall within the scope of the appended claims.

1. A spray booth comprising:
(a) a plenum for accepting air at a first pressure;
(b) a work area adjacent to the plenum;
(c) a filter having at least two permeabilities between the plenum and the work area.

2. The spray booth of claim 1 wherein the filter has at least two zones.

3. The spray booth of claim 1 wherein the filter has a first zone having the higher permeability.

4. The spray booth of claim 1 wherein the filter has three zones, and wherein the second zone has the lowest permeability.

5. The spray booth of claim 1 wherein the first zone is between 6 inches and 60 inches in width.

6. The spray booth of claim 1 further comprises an exhaust vent at a second pressure, wherein the second pressure is lower than the first pressure;

7. The spray booth of claim 1 further comprises a diffuser in said plenum.

8. The spray booth of claim 1 wherein the filter further comprises:
(a) a scrim mesh providing stiffness to the filter; and
(b) a loft incorporating a low permeability material.

9. The spray booth of claim 6 wherein the exhaust vent has a smaller surface area than the plenum.

10. A method of painting an object in a spray booth comprising the steps of:
(a) placing the object into a work area of the spray booth wherein the work area is separated from a plenum by a filter having at least two permeabilities;
(b) forcing air into the plenum at a first pressure
(c) exhausting air from the work area at a second pressure wherein the air travels around the object at a relatively higher velocity;
(d) painting the object wherein an overspray is entrained in the higher velocity air traveling around the object.

11. The method of claim 10 wherein step (a) comprises placing a vehicle into the work area.

12. The method of claim 10 wherein step (b) comprises providing heated air into the plenum.

13. The method of claim 10 wherein step (a) comprises placing an object into a work area wherein the filter has three zones of permeability.

14. The method of claim 10 wherein step (b) comprises diffusing air within the plenum with a diffuser.

15. A method of drying an object in a spray booth comprising the steps of:
(a) placing the object into a work area of the spray booth wherein the work area is separated from a plenum by a filter having at least two permeabilities;
(b) forcing air into the plenum at a first pressure
(c) exhausting air from the work area at a second pressure wherein the air travels around the object at a relatively higher velocity;
(d) painting the object wherein an overspray is entrained in the higher velocity air traveling around the object.

16. The method of claim 15 wherein step (a) comprises placing a vehicle into the work area.

17. The method of claim 15 wherein step (b) comprises providing heated air into the plenum.

18. The method of claim 15 wherein step (a) comprises placing an object into a work area wherein the filter has three zones of permeability.

19. The method of claim 15 wherein step (b) comprises diffusing air within the plenum with a diffuser.
